(19) United States
(12) Patent Application Publication
(10) Pub. No.: US 2021/0082006 A1
(43) Pub. Date: Mar. 18, 2021

(54) Token Generation and Allocation based on Measured Services

(71) Applicant: Alexandr Domokhovsky, Chicago, IL (US)

(72) Inventor: Alexandr Domokhovsky, Chicago, IL (US)

(21) Appl. No.: 17/024,207

(22) Filed: Sep. 17, 2020

Related U.S. Application Data
(60) Provisional application No. 62/901,897, filed on Sep. 18, 2019.

(51) Int. Cl. G06Q 30/02; H04L 9/32

(52) U.S. Cl. CPC G06Q 30/0279; H04L 9/3213

(57) ABSTRACT

Examples relate to methods and systems for implementing token generation and allocation based on measured services. A method may involve receiving, at a computing system, information that indicates a performance of an activity. The information may specify a duration of the performance of the activity. The method may further involve determining a profile associated with the performance of the activity based on the information and generating a token to represent the performance of the activity such that a value of the token depends on the duration of the performance of the activity. The method may also involve associating the token with the profile along with an alert that indicates that the token is available.

### CROSS REFERENCE TO RELATED APPLICATION

The present patent application claims priority to U.S. Provisional Patent Application No. 62/901,897, filed on Sep. 18, 2019, which is hereby incorporated by reference in entirety.

### BACKGROUND

Volunteering is generally considered an altruistic activity that might involve an individual or group of individuals providing services that aim to benefit another person, group, or organization. Each individual that voluntarily provides some sort of service is often referred to as a “volunteer.” As such, volunteers can often develop skills during a volunteering activity while also helping to promote goodness or improve quality of life for other people, animals, and/or the environment. Thus, volunteering can generally produce positive benefits for the volunteer as well as for the person or community served.

### SUMMARY

Disclosed herein are embodiments that relate to methods and systems for token generation and allocation based on measured services. An example system may provide a software platform that can connect, facilitate, and record interactions between potential volunteers, donors, sponsors, and nonprofits (e.g., charitable organizations). The platform may enable networking, token generation, sensor measurements, graphical user interfaces (GUIs), and other services to be utilized to help incentivize the different groups listed above to act in a mutually beneficial way that can produce social value.

In one aspect, the present application describes a method. The method involves receiving, at a computing system, information that indicates a performance of an activity, where the information specifies a duration of the performance of the activity. The method further involves determining a profile associated with the performance of the activity based on the information and generating a token to represent the performance of the activity such that a value of the token depends on the duration of the performance of the activity. The method further involves associating the token with the profile along with an alert that indicates that the token is available.

In another aspect, the present application describes a system. The system includes a database and a computing system. The computing system is configured to receive information that indicates a performance of an activity where the information specifies a duration of the performance of the activity. The computing system is further configured to determine a profile associated with the performance of the activity based on the information and configured to generate a token to represent the performance of the activity such that a value of the token depends on the duration of the performance of the activity. The computing system is also configured to associate the token with the profile along with an alert that indicates that the token is available.

In yet another example, the present application describes a non-transitory computer-readable medium configured to store instructions, that when executed by a computing system comprising one or more processors, causes the computing system to perform operations. The operations include receiving information that indicates a performance of an activity, where the information specifies a duration of the performance of the activity. The operations further includes determining a profile associated with the performance of the activity based on the information and generating a token to represent the performance of the activity such that a value of the token depends on the duration of the performance of the activity. The operations further involve associating the token with the profile along with an alert that indicates that the token is available.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE FIGURES

FIG. 1 is a block diagram illustrating a system, according to example embodiments.

FIG. 2 is a block diagram of a computing system, according to example embodiments.

FIG. 3 is a block diagram of a profile, according to example embodiments.

FIG. 4 is a flowchart of a method, according to example embodiments.

FIG. 5 illustrates a schematic diagram of a computer program, according to example embodiments.

### DETAILED DESCRIPTION

In the following detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

Volunteering typically involves one or more participants providing some type of service without an expectation of a financial reward (e.g., a monetary payback). There are numerous ways that a participant may choose to volunteer, such as attending and helping out at a coordinated event or another activity planned and managed by local and national organizations (e.g., charities, nonprofits). For instance, nonprofits frequently need participants to help support office work or provide assistance at fundraisers, which are often used to help generate funding for hospitals, schools, firehouses and police stations as well as other places within a community. In other cases, volunteers may opt to help clean up and protect the environment, take care of animals, and/or to work with other people. For example, a volunteer can mentor or tutor younger people or spend time helping other groups of people, such as elderly or disabled people. Volunteers can also contribute by providing specialized skills to help others without monetary payback (e.g., pro-bono legal or medical work). Overall, there are various ways a person can volunteer his or her time with the examples provided above representing a subset of available options.

Various factors may motivate people to volunteer including different intrinsic and extrinsic reasons. Some people view volunteering as an opportunity to give back to an organization, the community, or society in general as well as a way to make a difference in the lives of others. In some cases, a participant may volunteer to help the environment, animals, or other people that may need the assistance.

Volunteering can also cause participants who donate time and skills to feel valued and part of a team. In addition, participants can learn new skills, build a resume, improve employment prospects, make new friends, and gain confidence through volunteering. A participant may also volunteer his or her specialized skills and knowledge to benefit others. For example, teachers, lawyers, and nurses may volunteer their special skills to help others. As such, other reasons may encourage people to volunteer.

By providing services in various ways, volunteers can create good for a community and help improve society. Despite these potential benefits, it can often be difficult to recruit volunteers to participate in volunteering activities. The difficulty in recruiting volunteers can arise for various reasons. Many potential volunteers have busy lives that can make it hard to find opportunities that can accommodate their schedules. Particularly, volunteers may have families, work, and other obligations that can make signing up and an attending a volunteering event initially appear overwhelming, which can potentially prevent a volunteer from actually participating. As a result, nonprofits and other organizations seeking volunteers frequently struggle to connect potential volunteers with volunteering options.

In addition, volunteering opportunities might not be well advertised. This failure to capture the attention of potential volunteers may be due to the limited advertisement budgets that are available to nonprofits as well as a lack of a clear strategy to connect with potential volunteers. Particularly, potential volunteers are likely already bombarded with various types of advertisements daily and may fail to notice advertisements that describe details for volunteering activities as a result. Moreover, the advertisements and social media that do capture the attention of some potential volunteers can still have a low participation rate for various reasons.

Furthermore, nonprofits and other organizations can struggle to produce enough motivation for participants to volunteer. Some potential volunteers may lack the motivation to volunteer since they might assume that figuring out details related to a volunteering event, such as how and where to volunteer is too difficult or complicated. Additionally, some potential volunteers may also not expect to gain any benefits from volunteering and might feel that their actions will likely go unnoticed. As such, the hindrances described above represent only a few of the obstacles that nonprofits and other organizations may face when trying to recruit volunteers.

Along with the difficulties associated with recruiting volunteers, nonprofits and other organizations often also struggle to connect with potential donors and sponsors. Donors and sponsors include people, groups, and organizations (e.g., a company) that seek to provide monetary support in some capacity to help the causes of volunteering events and nonprofits. As such, nonprofits and other organizations frequently fail advertise ways to contribute to a volunteering event or cause that attract attention from a large amount of potential donors and sponsors. In some cases, organizations may also lack an efficient way to receive these funds from the potential donors and sponsors, which might discourage some potential donors or sponsors from providing contributions. In addition, some potential donors and sponsors may refrain from donating or sponsoring a nonprofit or organization due to a lack of transparency of how the funds are used or a lack of confidence associated with the donation processing system.

Example embodiments presented herein may help overcome the various obstacles associated with operating and funding volunteering events and activities described above. Some examples involve a system implementing a software platform designed to help increase the volunteer and donor participation for volunteering events. In particular, the platform may provide tools and interfaces (e.g., GUIs) that can connect potential volunteers, donors, and sponsors with volunteering opportunities, such as that local events aimed to benefit charities, schools, hospitals, the environment, or other nonprofits and organizations in the community. The platform may also enable participants to connect via platform-specific and/or existing social media elements (e.g., accounts, messengers, forums) that can help expand the reach of volunteering activities to encourage other potential volunteers, donors, sponsors, and organizations (e.g., nonprofits) to join. Thus, the platform may also help organizations, such as charities and other nonprofits reduce the amount of funds spent on advertisements to attract help and additional funding.

In some embodiments, the software platform may enable potential participants to join and use the platform by setting up a user profile. Both individuals and organizations (e.g., charities, nonprofits, and companies) may join the platform as users with profiles. In some embodiments, the platform may utilize specific GUIs that require a participant to provide enough information that enables a profile to be made (e.g., a threshold amount of user information). Once a user joins the platform, the platform may then assist the user in a variety of ways based on the profile and subsequent activities of the user, such as enable the user to advertise or discover volunteering events, provide or receive monetary support (e.g., donations, sponsorships), and perform other actions (e.g., connect with other users).

In some examples, the information provided by a user when setting up the account may be used to optimize the platform for the user. For instance, the platform may suggest volunteering events to a volunteer based on the volunteer's schedule, preferences, and skills recorded in his or her profile. The platform may also further customize the platform's use based on events associated with a profile over time, which may include actions performed by the user, such as donations, sponsorships, and/or volunteering events attended. For example, the platform may provide reminders to a user about a yearly event that the user has donated funds towards in the past and/or about a volunteering event that the user registered for. In addition, the platform may leverage machine learning via neural networks or another techniques to anticipate potential activities that a user may likely enjoy volunteering for (or sponsoring) based on prior activities of the user and/or interests listed within the user profile. As such, the platform may use one or more techniques to enhance the experiences of the users (e.g., questionnaires and feedback systems) and improve the effectiveness of the platform overall.

User profiles can also serve as a way to record events and activities for a user on the platform. Particularly, the platform may use a profile to record the volunteering services performed by a user, donations and sponsorships provided by the user, and other activity associated with the user of the profile (e.g., accounts links and information given by the user). The platform may be configured to securely store and keep this information private and only viewable by the user unless the user opts to make one or more elements of the information public. The platform may include privacy settings that enable a user to select which elements that the user would like to make public. For instance, a user may opt to make volunteering activities performed and monetary contributions provided public to encourage other users to do similar activities while keeping personal information (e.g., contract and personal information) private. As such, the privacy settings may be modified at any time by a user via user inputs.

In addition, the platform may use one or more security techniques to prevent unauthorized access to user profiles, such as two factor password authentication systems, biometric passwords (e.g., fingerprint), and/or other techniques. These security techniques may be used to limit access of a profile to only to the user that set up the profile and other users that the initial user granted access to (e.g., a business profile may enable multiple users to login to the same profile).

In some examples, the platform may enable a user to connect external accounts to a user profile. For instance, the user may connect bank accounts, email, webpages, URLs, and social media accounts, among others. By enabling integration of these external accounts with a user profile, the platform can be used more efficiently by the user, which may result in the platform requiring fewer inputs from the user to perform actions. For instance, the platform may receive and provide funds directly with the bank account of a user upon receiving permission and banking information from the user. This way, the user may quickly sponsor or donate monetary support to one or more volunteers or organizations through the platform without providing banking information (e.g., a credit card number) every time. Similarly, a nonprofit may receive donations and other monetary support directly through the platform by linking an external account with the platform. Thus, by enabling a user to connect external accounts, the platform may operate more efficiently and improve the user experience of all users.

In addition, linking external accounts can also expand the reach of the platform. Particularly, users may use social media accounts, messenger services, webpages, and other external accounts to further convey aspects of the platform, such as the performance of volunteering events and/or financial sponsorships or donations.

In some examples, non-users that do not register a profile with the platform may have access to a limited amount of features on the platform. For instance, the platform may enable a non-user to search for volunteering events to participate at, but require the non-user to join the platform by creating a profile in order to register with an organizer to participate at one of the events. By offering limited use, the platform may encourage exploration of the features of the platform by non-users while also promoting joining the platform to enable the platform to optimize each user's experience.

In additional examples, registered and non-registered users may have access to public sections of user profiles, such as profiles of registered nonprofits that contain descriptions and advertised volunteering opportunities. As such, the platform may enable registered and non-registered users to discover and reference volunteers, nonprofits, and sponsors (or donors) who are registered on the platform (if they chose to keep their profile public). For example, the platform may enable non-registered users to browse aspects of the platform before deciding to register, which may recruit more participation overall.

Within examples, the platform may be implemented across one or more computing systems and may use one or more interfaces, such as one or more web-based interfaces and/or mobile applications. For example, the platform may enable a user to access the platform on the user's smartphone via a mobile application. In such an example, users may join via downloading and creating profiles on the mobile application and/or registering online. In some examples, numerous computing systems may implement the platform in a decentralized or distributed arrangement (e.g., a blockchain configuration). The blockchain can enable different computing systems to serve as nodes that validate different transactions onto the blockchain without reliance on a central system serving as the primary validation point. In some example arrangements, the platform may link accounts of users without an indirect connection through the platform (e.g., a monetary donation is provided from the donor's account directly to the receiver's account).

As indicated above, the platform aims to help connect and facilitate interaction between multiple parties, such as volunteers, donors, sponsors, and nonprofits. One way that the platform may facilitate and increase interaction in a mutually beneficial way among the above parties can involve the generation and use of digital tokens. A digital token, also referred to herein as a token, may be generated and used by the platform to accomplish a variety of tasks. First, the platform may generate and provide a token (or an indication of the token) to the profile of a volunteer in recognition of a volunteered service provided by the volunteer. To illustrate an example, the platform may generate and provide a token to each volunteer who attended and participated at a volunteering event (e.g., cleaning up a waterway).

The use of tokens by the platform can vary within example embodiments. In some examples, the platform may generate a token for each hour of volunteering service provided by a user. For instance, when a user of the platform contributes five hours of volunteering services at an event, the platform may generate and provide five tokens to the user (e.g., associate five tokens with the user's profile). In other examples, the token may be generated based on the performance of a volunteering service over a different duration (e.g., thirty minutes). In this case, five hours of volunteering would result in ten tokens overall. Furthermore, the platform may also be configured to generate multiple tokens that can each represent a different duration of volunteered services (e.g., a first token representing an hour of service and a second token representing five hours of service performed).

In addition, the value associated with a generated token can be dynamic within some examples. In particular, although a token may be generated based on a quantity of volunteered time, the value associated with the token may depend on one or more other parameters. For instance, the value of a token can be determined based on the amount of funding received from sponsors and/or donors. As an example, the value of a token may be determined by the platform at the time of sponsorship based on predefined parameters and pricing strategy.

In some examples, the value of a generated token may depend on one or more parameters. For instance, a donor may opt to contribute money that is attributed evenly across all the tokens generated for volunteers that participated at a particular event (e.g., a charity walk). To illustrate an example, a donor may choose to donate a hundred dollars that is distributed across 20 tokens provided to volunteers for their services resulting in each token having a five dollar monetary value. Without a monetary contribution applied to a token, the token may serve as a non-monetary award to serve as recognition for the volunteered services provided by a volunteer. As indicated above, the platform may generate and award one or more tokens to a volunteer depending on the duration that the volunteer provided services.

In some examples, all of the monetary contributions received from donors and/or sponsors to fund tokens for volunteers at a particular event may be accumulated by the platform and subsequently distributed across the generated tokens. For instance, if a total of ten donors and sponsors give a collective ten thousand dollars ($10,000) in monetary contributions for a particular charitable event, the platform may distribute the ten thousand dollars evenly across the tokens generated for the event. As indicated above, the quantity of tokens generated may depend on the number of volunteers that provided services and the durations that each volunteer served. In some instances, the platform may further divide the ten thousand dollars in a manner that gives tokens particular values that depend on other potential factors, such as the actions performed and/or criteria provided by the donors or sponsors.

In some examples, the monetary value of a token may further depend on the types of services provided by the volunteers and/or other factors. This way, the platform may give higher value tokens to volunteers that provided a great contribution to the charitable event (e.g., certain positions, harder tasks). The parameters used to adjust values of tokens can depend on input from the organizers of the charitable event, such as parameters indicated by the organizers via a questionnaire provided to the profile(s) of the organizers.

The monetary value of a token can also be determined through a bidding process facilitated by a computing system. In an example, bidding is performed automatically by a platform according to pre-allocated monetary budgets of the bidders and/or based on parameters predefined by bidders. Bidders may be companies, volunteers, or other contributors (e.g., donors). To further illustrate, an example bidding system may include parameters representing a max cost per token, a max number of tokens to be sponsored per volunteer, a maximum sponsorship budget, and/or one or more minimum values imposed by the platform for these parameters. In addition, the system may also include a notification strategy that can help further participation and additional bidding. For example, the system may have a notification feed that can be used to promote brands or enable custom direct messages to be provided to sponsored volunteers (e.g., a specific marketing proposition). Upon the generation of a new token, the platform may be configured to select the winning bid among all bidders that match the target audience. As such, the winning bidder may be allowed to deliver a notification to the current owner of the token. In some examples, the platform may be configured to optimize for maximum funding per token and the most tokens per volunteers while also taking into account the type of the message that the bidder is interested in using to accompany with the token.

Some types of messages are predefined on the platform. In some examples, higher bid values for a token may be needed to obtain certain types of messages, such as ones with more details and customization. In other words, the bidder may be required to increase a bid for token if a custom email with many details is desired compare to a very brief generic pop-up notification.

The platform may also utilize constraints on the amounts of tokens that can funded by a donor or sponsor. For instance, the platform may have a minimum amount to ensure that a small monetary contribution is not spread too thinly across a large quantity of tokens. For example, the platform may require that each token receive at least 5 dollars when a donor's monetary contribution is divided among tokens. Similarly, the platform may also use a maximum amount per token in some instances (e.g., $500 dollar maximum per token). The value amounts set and used for the constraints can vary within examples. In some examples, an administrator may adjust the constraint values. In further examples, the constraints may be adjustable thresholds based on the monetary value provided by a donor or sponsor. For instance, a larger donation may have a higher minimum amount per token contribution to prevent the donation from being spread across too many tokens.

In addition, as indicated above, the platform may enable sponsors and donors to direct monetary contributions directly to the token or tokens of one or more volunteers. For instance, an organization may choose to direct a monetary contribution across the tokens of a certain group of volunteers using the platform. The platform may enable the organization to select the tokens of certain volunteers based on various factors, such as age group, skills used, location-based, and/or the types of events the volunteer participates at, among others.

As indicated above, some tokens may lack a monetary value when sponsorships or donors do not provide funding to back these tokens. In such a case, a token without a monetary pledge behind it may still serve as a way to give recognition to the volunteer for his or her contribution and record the contribution within the volunteer's profile. Thus, the token may be able to help motivate further volunteering by the user that received the token. When a token does have a monetary value due to a sponsor or a donor, the platform may enable the volunteer to choose where the monetary value is given. Particularly, the platform may request for the volunteer to select either the organization that operated the volunteering event that the volunteer participated at or another nonprofit of his or her choice.

In some examples, the platform may limit the destination options for the funds associated with the token based on one or more factors. For instance, the platform may limit the funds to only be sent to nonprofits with profiles on the platform and/or based on preferences of the sponsor or donor. This way, a sponsor or donor may also be able to have a degree of influence over the monetary contribution. For example, a company that manufactures outdoor goods may choose to sponsor tokens generated for a youth group volunteering and may even limit the destination of those funds to only the event or to a select number of nonprofits that align with the values of the company (e.g., cleaning the environment).

In additional example embodiments, the platform may enable sponsors to sponsor tokens that match both a volunteer's designation and a sponsor's limitation. For instance, the platform may match volunteers and donors and/or sponsors based on common criteria. When a target audience for sponsorship is selected, sponsors and/or donors may retain the ability to further limit which nonprofits (or nonprofit categories) that may receive their monetary contribution. In other words, the platform may enable monetary contributions to be distributed to nonprofits that match the interests of volunteers and the sponsors and/or donors.

To illustrate an example, the platform may have awarded a volunteer 10 tokens for services that she provided (e.g., 10 tokens for 10 hours of volunteering). As such, the platform may enable the volunteer to select destinations for contributing monetary values associated with the 10 tokens. For example, the volunteer may select via a platform interface to contribute ten percent of the total monetary value of the ten tokens (e.g., the monetary value of one token) to a local animal shelter where she volunteers periodically, fifty percent of the total monetary value of the ten tokens (e.g., the monetary value of five tokens) to a local juvenile homeless assistance center, and the remaining forty percent of the tokens' value to an environment nonprofit. In the above example, a donor (or a sponsor) who opts to contribute to the volunteer can provide preferences to the platform that limits the options that the volunteer can contribute to using the donor's contribution. For instance, the donor (or sponsor) can limit the options to only the homeless assistance center, which may cause the platform to only spread the donor's monetary contribution among the five tokens. The platform may be configured to further automatically readjust the designation of the remaining volunteer's tokens to maintain the volunteer's original designation balance (e.g., 20 percent of the remaining token monetary values to the local animal shelter and 80 percent to the environment nonprofit).

In addition, as indicated above, the platform may also enable the donor and/or sponsor to target a particular audience of volunteers. For instance, the platform may enable a user to provide monetary funding based on event, age groups, skill sets, location, and time of year, among others parameters. As a result, a company or another user may sponsor or donate to a specific audience of volunteers that can be based on one or more parameters. In some examples, a sponsor may sponsor tokens for a target audience to increase exposure to the audience. For instance, a company can promote a new product, the company's mission or philanthropy, and/or provide other information to a specific audience of volunteers. Thus, the platform may influence and help increase monetary contributions provided to nonprofits and other organizations providing volunteering services.

The use of tokens by the platform can further encourage participation and funding of volunteering events. First, the tokens may help motivate more volunteering. A volunteer may seek to provide services more often to accumulate more tokens and/or reach a higher level based on the gamification of volunteering by the platform's use of tokens. In addition, the volunteer can also publically share indications of the tokens via social media accounts, which may motivate others to join the platform and volunteer. Volunteers may also opt to volunteer more since they can influence where donations and sponsorships are directed.

Second, the tokens may also help motivate additional monetary support. As discussed above, donors and sponsors can specifically fund one or more tokens, which in turn modify the value of these token(s). The tokens backed by monetary funding can then be transferred to other volunteers for the performance of services and/or to nonprofits and other organizations that can use the funds to improve the community in some way. By gamifying and making donating and sponsoring easier, the platform may help increase overall contributions provided by individuals, groups, and organizations.

Third, the tokens can also increase overall exposure for all the parties that utilize the platform. The tokens can serve to recognize and award participation by volunteers and can encourage transfers of value to nonprofits and other organizations. In addition, sponsors can use tokens as a means to advertise. For instance, a sponsor can customize the digital appearance (e.g., colors, content of digital tokens) or other parameters of one or more tokens that the sponsor funds, such as a message that can accompany a token. Similarly, the sponsor can use the tokens to reach a target audience and may provide messages that are digitally included within the tokens (or along with) for the volunteers to view. As a result, volunteers that receive and share these tokens may see the sponsorship and learn about the funds provided by the company or other sponsors. Thus, in some situations, the platform may include a variety of tokens that are sponsored by one or more sponsors (e.g., a first set of tokens sponsored by a first sponsor and a second set of tokens sponsored by a second sponsor).

The platform may also be configured to support different types of messages in some embodiments. Some examples include notifications in the notification feed of a current token owner, a customized personal messaged delivered to a current token owner, and an email or text message with customized content sent based on user profiles, etc. In addition, the platform may facilitate direction messaging interaction between users.

In some examples, multiple types of tokens may be used by the platform. For instance, a first type of token may be used to represent volunteering activities performed by volunteers. Each volunteer's profile may be able to store a record and display these volunteer-based tokens. In addition, a second type of token may be used to represent funds provided by sponsors. These sponsor-based tokens may be used to indicate quantities of funds provided by sponsors and which sponsors provided the funds (e.g., companies, organizations). Another type of token may be donor-based tokens that can be used to represent funds received from donors. Other types of tokens may be used.

In addition, the platform may enable transferring of tokens between platform users, including between different volunteers. For instance, a volunteer may accumulate tokens from other volunteers and opt to provide the funding associated with all the tokens to a particular organization. This may also further encourage volunteers to help each other since tokens can be transferred as a way to thank others for assistance.

The platform may use techniques to monitor the performance of volunteering activities by volunteers. Example techniques may involve using information obtained from one or more sources, such as organizers of events and/or measured data from devices associated with volunteers. A few examples are discussed herein, but the platform may be designed to use other ways as well.

To illustrate, one technique for confirming that a volunteering event was performed and to what extent by a user may involve obtaining information from a mobile device associated with the volunteer. Particularly, the platform may be configured to use the information from the mobile device to monitor and/or measure volunteering activities performed by the volunteer. For instance, the platform may receive sensor measurements from a volunteer's mobile computing device (e.g., smartphone, wearable computing device) that can enable the platform to determine a value of the activities performed by the volunteer. The sensor measurements may include, for instance, a location of a user during a particular time and a quantity of steps performed by the user during the particular time. This way, the platform may use the information to determine that the user was at a volunteering event and generate a token for the user in response. As such, the value of a token awarded for a volunteered activity may depend on a quantity of steps performed by the volunteer during the volunteering activity, the duration of the volunteering activity, and/or other measurements (e.g., global positioning system (GPS) measurements that indicate the presence of a volunteer at a volunteering event). Thus, the use of profiles and other interfaces (e.g., mobile applications) may enable the platform to monitor volunteering activities performed by volunteers using the platform.

Another technique may involve receiving information from organizers of a volunteering event. For instance, an organization running a volunteering event may submit attendance and time records to the platform for subsequent analysis. In turn, the platform can award the volunteers with tokens and/or other forms of recognition. In some examples, the platform may analyze information provided by the organization using one or more algorithms that can identify participants and the quantity of participation time associated with each participant.

In yet another example, the platform may utilize a buddy-system that requires each volunteer to confirm the presence of one or more other volunteers at a particular volunteering event. The platform may place restrictions on the buddy-system, such as the volunteers may only submit information obtained using near field communication (NFC) with the device of another volunteer to confirm participation. In addition, the platform may require each volunteer to scan a QR code or sign in at an event in another way to confirm the participation of the volunteers. Other techniques may be used by the platform within examples. As such, the platform may be configured to carefully confirm participation at volunteering events by volunteers to prevent tampering of the platform and ensure that the monetary contributions provided are supporting actual volunteered services.

As discussed above, the platform may encourage further participation in the form of volunteering, donations, sponsorships, and other activity by utilizing social media aspects. In some instances, the platform may include one or more social media related interfaces (e.g., message boards, a messenger interface). In addition, the platform may include the ability to connect to external social media accounts (e.g., email, messenger, and mobile applications). Social media accounts can help increase user communication, activity, and encourage non-users to join the platform. Similar to advertisements, users can share their activity publically and with others people. This public sharing may encourage more people to donate and/or volunteer. Particularly, many people may aspire to join friends and help improve the community in some way.

As shown, example embodiments aim to increase participation in volunteering services, donations, sponsorship, and transparency of activity by incentivizing sponsors, volunteers, and nonprofit organizations to engage in a mutually beneficial relationship. In addition, the use of tokens and recording statistics can help optimize the platform for its users and gamify the process of volunteering and providing monetary contributions to support the volunteers, which may increase participation and funds provided overall. As a result, example embodiments may be able to empower social activism and produce positive impacts on communities.

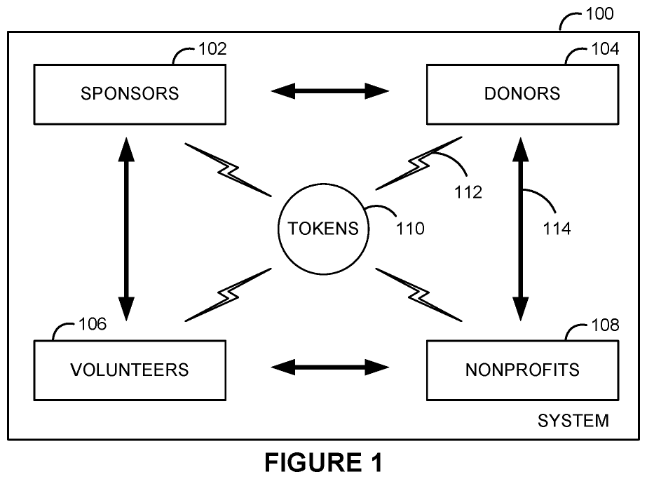

Referring now to the figures, FIG. 1 is a functional block diagram illustrating a system according to one or more example embodiments. The system 100 represents an example arrangement for implementing a platform that can enable interaction between sponsors 102, donors 104, volunteers 106, and nonprofits 108. The interaction between these different parties is represented by connections 112, 114 in FIG. 1 and may involve the promotion, sharing, funding, and performance of activities related to volunteering. As such, to enable the interaction, the system 100 may be implemented across one or more computing systems, such as a network of computing systems. These computing systems can vary in type and can include laptops, servers, mobile computing devices (e.g., smartphones, wearable computing devices), among other options. In some examples, the system 100 may operate across a network of computing systems participating in a decentralized configuration (e.g., a blockchain).

As further shown in FIG. 1, the system 100 may generate and use tokens 110 to help record, document, and reward activities performed by and/or interactions between the sponsors 102, the donors 104, the volunteers 106, and the nonprofits 108. As indicated above, the system 100 may generate and provide a token 110 to the profile of a volunteer as an award for the volunteer performing some type of volunteering service. This way, the system 100 may provide a token 110 to acknowledge the actions provided by the volunteer 106.

In addition, the system 100 may associate monetary values received from the donors 104 and the sponsors 102 with the tokens 110. Particularly, the monetary values for a token may depend on various parameters, such as input provided by one or more donors and/or sponsors and aspects of the volunteered service being represented by the token (e.g., skills used, quantity of time performed, and difficulty of the services). Thus, the value of a particular token 110 can vary and, in some examples, a token 110 can have multiple values (e.g., a monetary-based value and a service-based value).

In some examples, each token may represent a virtual (e.g., digital) creation generated and used by the platform to facilitate designation and allocation of sponsorship contributions from the sponsors 102 and the donors 104 to charitable organizations and other nonprofits 108. Each token may serve as an exchange unit between the volunteers 106 who provided pro bono services and can also enable analysis of activity patterns on the platform. To illustrate an example, a token may digitally include information encrypted as part of the token, such as the volunteering event, the original volunteer, the token's transaction history, and the current owner. This information may be readable or may require the system 100 to access this information. The data can exist on the platform's internal data storage and can be linked to individual users. As such, the system 100 may monitor and use tokens and exchanges to account for volunteering and sponsorship activity within the system 100.

In some instances, the value of a token may be used to determine the amount of tokens that can be sponsored by a monetary contribution. Token generation and management may enable a balance between pending sponsorship and contributions. The value of a token may be dynamic based on various parameters, such as the number of volunteers that match the selected target audience for current sponsorship, advertisement effectiveness, and supply and demand.

To enable interaction between the parties, the system 100 may use one or more interfaces. For instance, the system 100 may use one or more web-based and/or mobile-based applications that can enable individuals and companies to create profiles to be registered with the system 100. The system 100 may enable any user to register and create a profile for use on the platform. A user may correspond to an individual or an entity (e.g., a group of individuals, a company, etc.). As such, these profiles may be used to monitor, store, and maintain information related to each user.

In addition, the system 100 may use one or more external application programming interfaces (APIs). These APIs may facilitate integration into external systems. An example API includes an end point API designed to receive volunteering opportunities posted by volunteering aggregators. This may enable the system 100 to determine and present opportunities for review and selection. Another example API may include one or more public APIs to integrate into an existing a corporate social responsibility software solution for corporate sponsorship. Yet another example API may provide licensed access to platform usage analytics.

The system 100 may also enable participants (e.g., the sponsors 102, the donors 104, the volunteers 106, and the nonprofits 108) to link external social network accounts to registered profiles. For instance, a volunteer 106 or a company (e.g., a sponsor 102) may link the profile to various external accounts to increase visibility and connectivity to other participants. The system may also enable connecting a profile to external applications, such as email clients, messenger applications, etc.

As shown in FIG. 1, the sponsors 102 may use the platform implemented by the system 100 and may correspond to individuals, groups, and organizations that choose to sponsor tokens via monetary contributions. Particularly, each sponsor 102 may participate in the act of volunteering sponsorship, which may involve providing monetary contributions to charitable organizations and other nonprofits in consideration of volunteering services provided by volunteers 106.

In some examples, a sponsor 102 may provide funds directly to a charitable organization or another group that organized a volunteering event. In turn, the organization or group may provide a notification to the system 100 that enables the platform to associate the funds received from the sponsor 102 with one or more tokens generated as awards for participants of the volunteering event. In some instances, the system 100 may facilitate the transaction by receiving the funding via an interface and enabling the sponsor 102 to select one or more volunteering activities to sponsor with the funds and/or the tokens of a specific group of volunteers (e.g., a certain age group in a particular location) to sponsor. The system 100 may provide some suggestions for a sponsor 102 to use based on information provided by the sponsor 102 in the sponsor's profile and/or based on prior sponsorship trends associated with the profile.

In some examples, the sponsors 102 may choose to sponsor tokens as an advertisement strategy. When sponsorship is for advertisement purposes, the funding provided by the sponsorship may not qualify for a charitable contribution tax emption. In such cases, no receipt for a charitable contribution may be issued. This may be one way that the system 100 differentiates between the sponsors 102 and the donors 104. As such, the platform implemented by the system 100 may provide suggestions on how to advertise using tokens, such as customizing the appearance of a set of tokens, including messages, images, audio, and/or video with the tokens. To illustrate an example, a company may decide that all tokens generated to reward volunteers at a particular event include a coupon for a product that the company produces.

The donors 104 may be another party of the system 100 and can represent individuals and organizations that may make charitable contributions in light of volunteering actions. These charitable contributions may qualify as tax-deductible contributions since the contributions are provided without expectation of any benefits received in return (i.e., not for advertisement purposes). As such, receipts for these charitable contributions may be provided. Similar to the sponsors 102, the platform implemented by the system 100 may enable the donors 104 to direct funds in a particular way (e.g., to give value to particular organizations and/or the tokens of a group of volunteers).

The volunteers 106 may represent individuals and groups that may provide volunteering services. Volunteering services may include contributions of time, skills, and/or expertise provided by the volunteers 106. As such, each volunteer 106 may be eligible for token allocation in return for his or her contribution.

As indicated above, when a new volunteer 106 registers with the system 100, the volunteer may create a profile. The profile may request for information about the volunteer 106, such as name, address, and volunteering and notification preferences. The volunteering preferences may enable customization of the presentation of volunteering opportunities for the volunteer 106 based on skills and interests. For instance, each volunteer 106 may provide skills, interests, preferences for locations, time of day, cause, and specific organizations, etc. In addition, the profile may also help a volunteer establish a public and/or private record of activities that the volunteer has performed and any funds that the volunteer may have helped raise. The platform implemented by the system 100 may use the information obtained from user profiles to help optimize the platform for users, including helping connect users with opportunities that align with their interests and other users that may share these interests. As a result, the platform may encourage further engagement with the platform and various users (e.g., other volunteers, donors, sponsors, and nonprofits).

As indicated above, the system 100 may grant tokens 110 to the volunteers 106 as a way to quantify the time contributions and other efforts provided by the volunteers 106. As such, the system 100 may use profiles to monitor and record the granted tokens each volunteer 106 receives, which can enable public recognition of the contributions each volunteer 106 makes if a volunteer chooses to share this information publically. Particularly, the profiles may display quantities of tokens received by a volunteer over time. As such, the system 100 may establish a verifiable record of volunteering efforts performed by the volunteer 106. Thus, potential employers and agencies may be able to review and confirm volunteered activities of a user if the user wishes to share access to one or more external entities. In some embodiments, a court system may use the system 100 to monitor community service hours contributed by a user.

In addition, the system 100 may also enable the volunteers 106 to elect to contribute their time, skills, and expertise to other volunteers on the platform. Particularly, volunteer-to-volunteer help requests may be listed and categorized in the same manner as nonprofit volunteering opportunities by the system 100. In some instances, the system 100 may require a volunteer 106 to submit a quantity of tokens that the volunteer 106 may transfer upon completion of a task in order to list a help request. The system 100 may require the volunteer 106 listing the opportunity to have the tokens available and may pre-authorize these tokens to ensure that performance of the requested task is rewarded accordingly. This amount can be revised until the request is accepted. The system 100 may also enable the listing to be removed and the pre-authorized tokens released unless someone accepted the request. Any token that has not yet been sponsored may follow the sponsorship designation of the recipient volunteer upon transfer.

The design of the platform implemented by the system 100 may help increase the number of opportunities available to the volunteers 106. Particularly, the platform may enable users to post volunteering opportunities via a software interface. In addition, the platform may also use public connectivity interfaces to access external volunteering opportunities. For example, the platform may use one or more external volunteering aggregators to discover external listings. The platform may organize the opportunities based on various parameters and make these opportunities available for review by the volunteers 106. For instance, the system 100 may utilize a search engine that enables the volunteers 106 to view subsets of available opportunities based on specific criteria, such as date, location, and skills needed, etc. The system 100 may also enable parties to send direct invites to the volunteers 106 regarding specific opportunities. In some examples, sending a direct invite may require a prior approval from a volunteer, such as a previous connection with the requester or based on settings set by the volunteer.

The nonprofits 108 may represent charitable organizations and other entities that typically conduct operations not for profit. Particularly, the nonprofits 108 may include organizations that qualify to receive tax deductible charitable contributions according to rules within the operating region. For instance, the nonprofits 108 may include organizations that qualify as nonprofits according to the rules defined in the IRS publication 526. As such, the nonprofits 108 may provide traditional and skill based volunteering opportunities for the volunteers 106 to participate in. In addition, the nonprofits 108 may receive financial sponsorship from the donors 104 and/or the sponsors 102.

Although FIG. 1 shows participating parties as part of defined groups (e.g., the sponsors 102, the donors 104, the volunteers 106, and the nonprofits 108), a party may be perform actions that qualify under multiple groups. For instance, in some embodiments, a registered individual can act as a volunteer 106 or as a donor 104 interchangeably. Particularly, the current categorization for the registered individual may depend on the type of activity that he or she chooses to engage in at a given point of time. Similarly, in some embodiments, a registered for-profit organization can act as a sponsor 102 or as a donor 104 interchangeably. The categorization may depend on the type of activity that the registered for-profit organization chooses to engage in at that point in time, such as whether if the actions by the organization are for advertisement purposes. In additional embodiments, a registered nonprofit organization can act as a nonprofit 108, as a donor 104, and/or as a sponsor 102.

The system 100 may enable feedback to be provided by any of the parties utilizing the platform. For instance, the system 100 may request for feedback from the volunteers 106 upon performance of a volunteering activity. As a result, the system 100 can help refine and improve the volunteering process by enabling feedback to be exchanged between interacting parties. The feedback may be stored and accessible by the various parties.

Similarly, the system 100 may also enable parties to invite non-users to join the platform. This may expand the reach of volunteering events. For example, the volunteers 106 may use an interface of the platform to request for sponsorships and donations. To illustrate an example, an employee who engages in pro bono activities may share an invite to have his or her tokens sponsored by his or her employer. In another example, youths volunteering at a local food repository may invite family members and friends over social networks to contribute donations or sponsor their efforts.

In some embodiments, the system 100 may enable the sponsors 102 and the donors 104 to pick and choose which volunteers 106 to be sponsored. This enables the sponsors 102 and the donors 104 to reach a particular audience with a direct message. As such, the selection scale can be as narrow as a specific volunteer or as wide as the entire volunteer user group on the platform implemented by the system 100. The customization by the system 100 can enable a variety of relationships between the sponsors 102, the donors 104, the volunteers 106, and the nonprofits 108. For example, a corporation that is interested in brand promotion among a certain volunteer population may sponsor any volunteer that falls within a specific age group and who also volunteers for services that align with the mission of the corporation (e.g., outdoor activities, helping disabled people).

In another example, a company that produces beverages may opt to sponsor volunteers 106 that provide services related to cleaning waterways, reducing pollution (e.g., removing plastics from a lake), and/or improving access to potable water in developing countries, among similar activities. To further illustrate, an additional example may involve a sponsor 102 to sponsor volunteers with a particular skill set (e.g., an accounting software company sponsoring accountants). Similarly, in some examples, parents may use the system 100 to sponsor or donate monetary support to encourage children to volunteer their time in a particular way (e.g., at a local pet shelter). In addition, an employer may use the system 100 to sponsor employees for volunteering services.

In some embodiments, the system 100 may use notifications to alert interaction between parties using the platform. For instance, the volunteers 106 may receive notifications about tokens they received that were sponsored by one or more sponsors 102. A notification may include details about the sponsor or the donor who provided the monetary funding in support of a volunteered service, such as a monetary contribution that matcher their designation, the amount of tokens that were sponsored, name of the sponsor or donor, and a brief message from the sponsor or donor. Similarly, the nonprofits 108 may receive notifications about the source of a contribution along with the monetary contribution. For instance, the notification may include the details about the sponsor or the donor, the amount of tokens that was designated to the nonprofit 108, and the total amount of tokens still pending sponsorship that are designated to the nonprofit 108.

The system 100 may also help implement an impact on communities. Particularly, monetary contributions that are used to sponsor tokens can be directed efficiently to charitable organizations and other nonprofits. As a result, the nonprofits 108 and other organizations that receive the funding can reduce and/or avoid spending money on advertisements and devote these funds as well as received monetary contributions towards their activities or mission in general. In some examples, the nonprofits 108 may receive monetary contributions without an increase in fundraising expenses. In addition, the monetary contributions from the sponsors 102 and the donors 104 can help amplify volunteer's efforts, which may incentivize further volunteering. In some examples, the sponsors 102 and the donors 104 may empower volunteers 106 by enabling the volunteers 106 to direct funds towards one of the nonprofits 108 previously selected by the sponsors 102 and the donors 104.

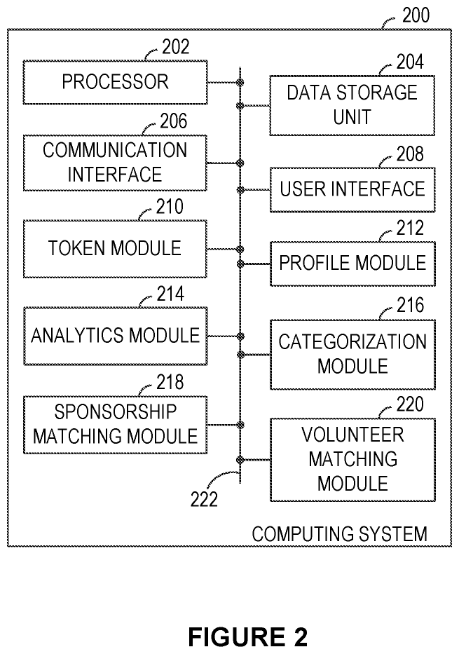

FIG. 2 is a block diagram of a computing system, according to an example implementation. The computing system 200 may implement the system 100 (or a portion of the system 100) and may perform various acts and/or functions, such as those described in this disclosure. For example, the computing system 200 may be part of a network of computing systems that implement the platform described above.

As such, the computing system 200 may include components, such as a processor 202, a data storage unit 204, a communication interface 206, a user interface 208, a token module 210, a profile module 212, an analytics module 214, a categorization module 216, a sponsorship matching module 218, and a volunteer matching module 220. The components can be connected to each other (or to another device, system, or other entity) via a connection mechanism 222, and can include more or less components in other example implementations. In other embodiments, the computing system 200 may be implemented across multiple computing devices operating within a network, such as multiple computing system arranged in a distributed network.

In this disclosure, the term “connection mechanism” means a mechanism that facilitates communication between two or more devices (e.g., computers, servers), systems, or other entities. For instance, a connection mechanism can be a simple mechanism, such as a cable or system bus, or a relatively complex mechanism, such as a packet-based communication network (e.g., the Internet). In some instances, a connection mechanism can include a non-tangible medium (e.g., where the connection is wireless).

The processor 202 may represent one or more general-purpose processors (e.g., a microprocessor) and/or one or more special-purpose processors (e.g., a digital signal processor (DSP)). As such, the processor 202 may include a combination of processors within examples. The processor 202 may perform operations, including processing data received from the other components within the computing system 200 and data obtained from sources, such as the various entities shown in FIG. 1.

The data storage unit 204 may include one or more volatile, non-volatile, removable, and/or non-removable storage components, such as magnetic, optical, or flash storage, and/or can be integrated, in whole or in part, with the processor 202. As such, the data storage unit 204 may take the form of a non-transitory computer-readable storage medium, having stored thereon program instructions (e.g., compiled or non-compiled program logic and/or machine code) that, when executed by the processor 202, cause the computing system 200 to perform one or more acts and/or functions, such as those described in this disclosure. Such program instructions can define and/or be part of a discrete software application. In some instances, the computing system 200 can execute program instructions in response to receiving an input, such as from the communication interface 206 or the user interface 208. The data storage unit 204 may also store other types of data, such as those types described in this disclosure.

In some examples, the data storage unit 204 may serve as storage for tokens generated by the token module 210, for profiles generated by the profile module 212, and for activity and analytics information determined by the analytics module 214. The data storage unit 204 also can store instructions executable by the processor 202 to perform functions of the computing system 200. For example, any of the modules described herein may take the form of instructions executable by the processor 202 and the instructions can be stored on the data storage unit 204.

The communication interface 206 can allow the computing system 200 to connect to and/or communicate with another entity (e.g., another computing device) according to one or more protocols. In an example, the communication interface 206 can be a wired interface, such as an Ethernet interface or a high-definition serial-digital-interface (HD-SDI). In another example, the communication interface 206 can be a wireless interface, such as a cellular or Wi-Fi interface. A connection can be a direct connection or an indirect connection, the latter being a connection that passes through and/or traverses one or more entities, such as a router, switcher, or other network device. Likewise, a transmission can be a direct transmission or an indirect transmission. The communication interface 206 may also utilize other types of wireless communication to enable communicating with one or more aircraft.

The user interface 208 can facilitate interaction users and the platform interfaces implemented by the system 100. As such, the user interface 208 can include input components such as a keyboard, a keypad, a mouse, a touch-sensitive panel, a microphone, and/or a camera, and/or output components such as a display device (which, for example, can be combined with a touch-sensitive panel), a sound speaker, and/or a haptic feedback system. More generally, the user interface 208 can include hardware and/or software components that facilitate interaction between the computing system 200 and one or more users of the computing system 200 and/or other computing systems.

The token module 210 represents a subsystem of the computing system 200 that can generate tokens. In particular, the token module 210 may generate one or more types of tokens that can be used to monitor and record activities performed by users of the system 100. In some examples, each token may have a dynamic value that depends on one or more parameters. Example parameters may include, but are not limited to, the number of volunteers that match the selected target audience for a current sponsorship, advertisement effectiveness, supply and demand, and/or inputs provided by users of the platform. For instance, the more volunteers who will be reached and notified about a contribution may drive the intrinsic advertisement value of a token higher. As a result, the value of the token may be higher.

In some examples, the digital signature of a token generated by the token module 210 may differ for each token. This way, each token generated may be unique and can be monitored by the platform across transactions, exchanges, and other activity. The digital signature may be encrypted or partially encrypted such that access to the signature is limited. For instance, only the platform may be able to access the entire digital signature. In some examples, once a token is generated, the digital signature that uniquely identifies the token and value of the token may not be modified. In some instances, a blockchain may be utilized such that a ledger of the token is distributed across multiple computing devices to increase security of the token.

The profile module 212 may include one or more subsystems configured to enable the computing system 200 to generate, store, and modify profiles for users of the platform implanted by the system 100. The profile module 212 may use one or more tools to enable efficient creation and modification of profiles by users of the platform. For instance, the profile module 212 may use a tutorial and questionnaire to help obtain and populate the information needed from a user to create a profile.

The analytics module 214 may be configured to generate and use analytics to help facilitate interaction between the parties using the platform. In some examples, the analytics module 214 may aggregate activity analytics based on token generation, designation, sponsorship, and transfer. As such, users may access the analytics. In addition, the computing system 200 may provide the analytics for external research purposes under a licensed agreement. In some examples, the computing system 200 may use the analytics to improve its services, such as refining token values and improving volunteering suggestions.

The analytics module 214 may enable the computing system 200 to confirm activities performed by volunteers. For instance, the analytics module 214 may include an interface that enables confirmation of participation with an event organizer. The event organizer may assist the computing system 200 approve an activity and determine an amount of time that the volunteer(s) performed the activity. In some examples, the analytics module 214 may require a nonprofit to approve, deny, or adjust hours within a certain time frame or adhere to other constraints that prevent volunteered hours to remain un-allocated. Failure to take action may result in a potential functional limitation of the nonprofit, such as a temporary exclusion from sponsorship allocations. In some examples, the analytics module 214 may include an interface that can connect with the time system used by a nonprofit. In additional examples, the analytics module 214 may automatically detect anomalies to reduce potential mistakes or intentional misconduct. For instance, an anomaly may correspond to overlapping hours logged at two distant volunteering events at the same time by the same volunteer.

The categorization module 216 may represent a module performed by the computing system 200 that can associate the interests and skills of volunteers into different categories. By categorizing the information provided by each volunteer, the platform may be able to organize volunteers according to different categories, such as ages, likes, locations, skills, and interests, among other categories. The categorization module 216 may further categorize users of the platform based on other information. For instance, the categorization module 216 may arrange nonprofits into categories based on volunteering activities organized by each nonprofit, locations of the nonprofits, missions of the nonprofits, and other information. Similarly, the categorization may also organize users based on monetary contributions and other preferences. In some instances, a user profile may be associated with multiple categories.

The computing system 200 may use categorizes developed by the categorization module 216 to establish connections between users of the platform. For example, the platform may use the categories to connect volunteers with potential volunteering options based on interests, locations, and/or other categories. The platform may use the categories to similarly connect nonprofits to potential volunteers and donors/sponsors to opportunities for directing monetary funding towards based on the categories developed by the categorization module 216.

The sponsorship matching module 218 may enable the computing system 200 to match monetary donations to tokens generated by the token module 210. The sponsorship matching module 218 may use information about volunteers to match monetary contributions to the activities of the volunteers.

The volunteer matching module 220 may use categories and other information to connect user profiles to volunteering events. Particularly, the computing system 200 may use the volunteer matching module 220 to recommend volunteering events to volunteers based on interests and other information (e.g., past performed volunteering events).

In some examples, the computing system 200 may further be configured further incentivize volunteers using a fee sharing process. Particularly, a portion of a monetary contribution may be allotted to one or more volunteers in the form of a monetary reward and/or monetary incentive at a sponsor (e.g., coupons, gift cards). The amount allotted to the volunteers may depend on the volunteer's activity level (e.g., based on quantity of generated tokens received by the volunteer). In some examples, the computing system 200 may enable volunteers to opt out of the fee sharing process and/or designate one or more nonprofits for receiving the fees.

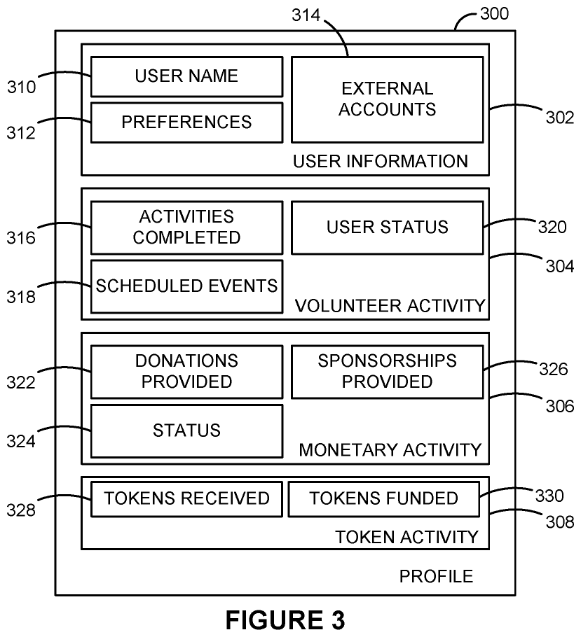

FIG. 3 is a block diagram of a profile, according to one or more embodiments.

The profile 300 represents an example configuration of a profile that the platform implemented by the system 100 shown in FIG. 1 may enable a user of the platform to populate. As shown in FIG. 3, the profile 300 includes user information 302, volunteer activity 304, monetary activity 306, and token activity 308. In other examples, the profile 300 may include other information in different arrangements.

The profile 300 may be implemented by the profile module 212 of the computing system 200 to enable a user to register with the system 100. Particularly, by enabling users to register with the system 100, the system 100 can monitor activities of each user and help record events performed by the user as well as monetary donations provided by the user. The profile 300 can be used to help facilitate interaction between the user associated with the profile 300 and other users, such as events for volunteering and potential sponsors and donors. As such, the system 100 may generate numerous profiles for users.

The user information 302 may include information related to a user, such as a user name 310, preferences 312, and external accounts 314. The profile 300 may include the user information 302 to help customize the system 100 for each user. For instance, the user name 310 may include contact information that enables other users to contact the user associated with the profile 300. As such, the user name 310 may include the name of an individual, a group, or an organization (e.g., a company) within examples.

The preferences 312 may enable the user to input volunteering preferences (e.g., activities, locations), sponsorship and donation preferences, user skills, privacy settings, and other information that can be used by the system 100 to help customize the system 100 for the user. To further illustrate, some example preferences include skills categorization, volunteering interests, types of activities, time of day, causes, and specific nonprofits. In addition, the preferences 312 may include notification preferences, such as how, when, and what notifications the user would like to receive. Some notifications include push notifications from the platform, sponsorship notifications, opportunities suggested by other volunteers or organizations, token designations, invitations from other platform users (e.g., connection requests, volunteer event invitations), and activity analytics (e.g., gamification element notifications). The preferences 312 may also include public profile visibility preferences, such as what to show publically and what to keep private. As such, the system 100 may use the preferences 312 to help make volunteer or donation suggestions for the user. The external accounts 314 may include accounts that the user connects with the profile 300, such as messenger systems, social media platforms, and bank accounts, etc.

The volunteer activity 304 may include volunteer-related information associated with the user of the profile 300. As shown, the volunteer activity 304 may include information related to activities completed 316, scheduled events 318, and a user status 320. The activities completed 316 may convey a record of past volunteering-related activities that the user completed. Similarly, scheduled events 318 may indicate upcoming events that the user signed up for or flagged for further review. The system 100 may also provide suggestions under scheduled events 318 for additional opportunities that the user may participate within. The user status 320 may indicate other information related to the user's status as a volunteer. For example, the user status 320 may specify whether the user is seeking new opportunities for volunteering or currently unavailable. In some examples, the user status 320 may be used to indicate some sort of rank for the user that depends on a quantity of volunteering activities that the user has completed. By ranking volunteers on the system 100, the system 100 may be able to encourage users to volunteer more to improve their ranking relative to others.

The monetary activity 306 may indicate information related to monetary contributions provided by the user associated with the profile 300. For instance, the monetary activity 306 may include donations provided 322, status 324, and sponsorships provided 326. The status 324 may indicate account related information for the user of the profile 300.

The token activity 308 may include information related to tokens associated with the profile 300. The token activity 308 may include tokens received 328 and tokens funded 330. The tokens received 328 may include indications of the tokens received from the system 100 as rewards for volunteering activities performed by the user associated with the profile 300. The tokens funded 330 may represent the different tokens that the user may have provided funding towards (e.g., sponsorship, donation).

In some examples, the profile 300 may further include a QR code or another unique identifier that can help users connect with others. For instance, a user may send her profile's unique code to one or more other users as a way to connect the profiles on the platform. In addition, the unique identifier can be used by the platform as a way to access each profile specifically without reliance on personal information provided for the profile. This may enable activity to be associated only with unique identifiers, which can keep personal information separate. As such, the platform may be configured to analyze activity on the platform between profiles only based on unique identifiers in some examples.

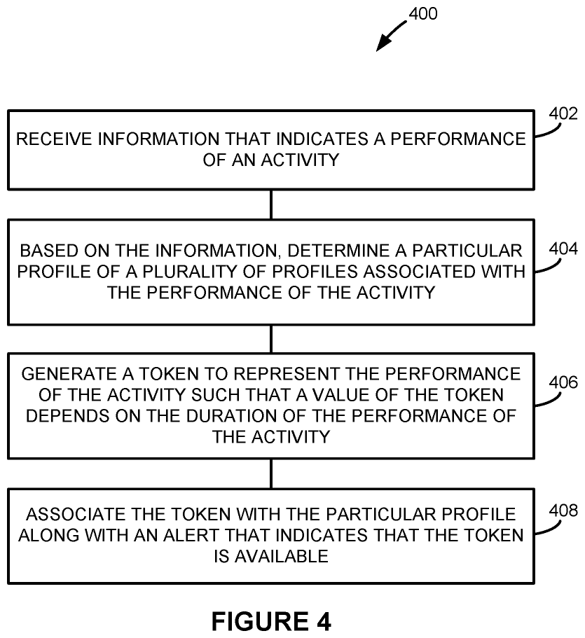

FIG. 4 is a flowchart of an example method 400 for token generation and allocation based on measured services. Method 400 represents an example method that may include one or more operations, functions, or actions, as depicted by one or more of blocks 402, 404, 406, and 408, each of which may be carried out by any of the systems shown in prior figures, among other possible systems.

Those skilled in the art will understand that the flow chart described herein illustrate functionality and operation of certain implementations of the present disclosure. In this regard, each block of the flowchart may represent a module, a segment, or a portion of program code, which includes one or more instructions executable by one or more processors for implementing specific logical functions or steps in the process. The program code may be stored on any type of computer readable medium, for example, such as a storage device including a disk or hard drive.

In addition, each block may represent circuitry that is wired to perform the specific logical functions in the process. Alternative implementations are included within the scope of the example implementations of the present application in which functions may be executed out of order from that shown or discussed, including substantially concurrent or in reverse order, depending on the functionality involved, as would be understood by those reasonably skilled in the art.

At block 402, the method 400 involves receiving information that indicates a performance of an activity. The system 100 shown in FIG. 1 may be implemented by one or more computing systems (e.g., the computing system 200 shown in FIG. 2) that can monitor activities associated with profiles. As such, a computing system may receive an indication that a user associated with a particular profile performed an activity, such as volunteering at an event.

In some embodiments, a computing system may receive sensor data from another computing device (e.g., a mobile computing device) and/or sensor that indicates the performance of the activity. The sensor data may include movement, duration, and/or location-based information. For instance, sensors providing the information may include GPS systems, inertial measurement units (e.g., accelerometer, gyroscope), and clocks, among others. In addition, a computing system may receive the information that indicates the performance of an activity from a computing system associated with facilitating the activity. The computing system may also receive information that indicates the performance of the activity in other ways, such as the scanning of a QR code.

At block 404, the method 400 involves determining a particular profile of a plurality of profiles associated with the performance of the activity based on the information. As indicated above, the platform may enable users to register and create profiles that can be used to customize activities on the platform. As such, the computing system may use the information to identify the profile of the user that performed the activity (e.g., the profile of the volunteer that volunteered services. The particular profile may be determined based on various ways, such as the information received at block 402 may include an indication of the profile.

At block 406, the method 400 involves generating a token to represent the performance of the activity such that a value of the token depends on the duration of the performance of the activity. For example, the token module 210 of the computing system 200 may be configured to generate the token. As discussed above, the value of the token can be based on one or more values, such as the duration of the performance of the activity and one or more monetary contributions provided by other users of the platform (e.g., donors, sponsors).

At block 408, the method 400 involves associating the token with the profile along with an alert that indicates that the token is available. For instance, the computing system may transmit the token (or an indication of the token) to a mobile application associated with the profile (e.g., a cold wallet).

In some embodiments, the method 400 may involve obtaining, at the computing system, information representative of a set of activities. The information may include parameters specifying time, location, and skills needed for each activity. The method may further involve providing a first alert to a first set of profiles having preferences that align with the parameters corresponding to a first activity of the set of activities and providing a second alert to a second set of profiles having preferences that align with the parameters corresponding to a second activity of the set of activities. As such, the particular profile may be in one or both of the first set of profiles and the second set of profiles. Particularly, the computing system may receive information that indicates the performance of the first activity or the second activity and use this information to award a token of the user of the particular profile for performance of the activity.

In some embodiments, the method 400 may further involve receiving a monetary sponsorship from a second profile where the monetary sponsorship is received with an indication to associate the monetary sponsorship with the performance of the activity. As such, the computing system may generate the token such that the value of the token further depends on the monetary sponsorship received from the second profile and such that the token includes a representation corresponding to the second profile (e.g., a message or advertisement).

In some embodiments, the method 400 may further involve receiving a monetary donation from a third profile where the monetary donation is received with an indication to associate the monetary donation with the performance of the activity. The computing system may generate the token such that the value of the token further depends on the monetary donation received from the third profile.

In some embodiments, the method 400 may further involve providing the token to another profile based on input received from the particular profile. Particularly, the user of the particular profile may decide to have a monetary value of the token given to the profile of a nonprofit that can use the monetary value to help the community.

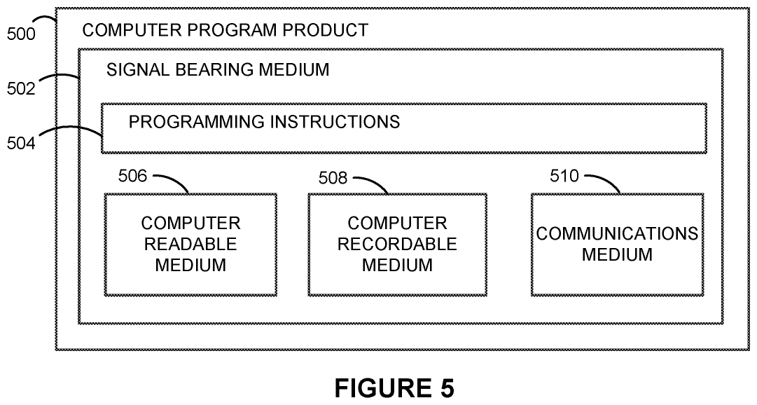

FIG. 5 is a schematic illustrating a conceptual partial view of an example computer program product that includes a computer program for executing a computer process on a computing device, arranged according to at least some embodiments presented herein. In some embodiments, the disclosed methods may be implemented as computer program instructions encoded on a non-transitory computer-readable storage media in a machine-readable format, or on other non-transitory media or articles of manufacture.

In one embodiment, example computer program product 500 is provided using signal bearing medium 502, which may include one or more programming instructions 504 that, when executed by one or more processors may provide functionality or portions of the functionality described above with respect to FIGS. 1-4. In some examples, the signal bearing medium 502 may encompass a non-transitory computer-readable medium 506, such as, but not limited to, a hard disk drive, a Compact Disc (CD), a Digital Video Disk (DVD), a digital tape, memory, etc. In some implementations, the signal bearing medium 502 may encompass a computer recordable medium 508, such as, but not limited to, memory, read/write (R/W) CDs, R/W DVDs, etc. In some implementations, the signal bearing medium 502 may encompass a communications medium 510, such as, but not limited to, a digital and/or an analog communication medium (e.g., a fiber optic cable, a waveguide, a wired communications link, a wireless communication link, etc.). Thus, for example, the signal bearing medium 502 may be conveyed by a wireless form of the communications medium 510.

The one or more programming instructions 504 may be, for example, computer executable and/or logic implemented instructions. In some examples, a computing device such as the computer system 200 of FIG. 2 may be configured to provide various operations, functions, or actions in response to the programming instructions 504 conveyed to the computer system 200 by one or more of the computer readable medium 506, the computer recordable medium 508, and/or the communications medium 510.

The non-transitory computer readable medium could also be distributed among multiple data storage elements, which could be remotely located from each other. Alternatively, the computing device that executes some or all of the stored instructions could be another computing device, such as a server.

The above detailed description describes various features and functions of the disclosed systems, devices, and methods with reference to the accompanying figures. While various aspects and embodiments have been disclosed herein, other aspects and embodiments will be apparent. The various aspects and embodiments disclosed herein are for purposes of illustration and are not intended to be limiting, with the true scope being indicated by the following claims.

It should be understood that arrangements described herein are for purposes of example only. As such, those skilled in the art will appreciate that other arrangements and other elements (e.g. machines, apparatuses, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

What is claimed is:

1. A method comprising:
receiving, at a computing system, information that indicates a performance of an activity, wherein the information specifies a duration of the performance of the activity;
based on the information, determining a particular profile of a plurality of profiles associated with the performance of the activity;
generating a token to represent the performance of the activity such that a value of the token depends on the duration of the performance of the activity; and
associating the token with the particular profile along with an alert that indicates that the token is available.

2. The method of claim 1, wherein receiving information that indicates the performance of the activity comprises:
receiving sensor data from a mobile computing device associated with the particular profile that indicates the performance of the activity, wherein the sensor data includes movement and duration information.

3. The method of claim 1, wherein receiving information that indicates the performance of the activity comprises:
receiving the information from a second computing system associated with facilitating the activity.

4. The method of claim 1, further comprising:
receiving a monetary sponsorship from a second profile, wherein the monetary sponsorship is received with an indication to associate the monetary sponsorship with the performance of the activity; and
wherein generating the token to represent the performance of the activity such that the value of the token depends on the duration of the performance of the activity further comprises:
generating the token such that the value of the token further depends on the monetary sponsorship received from the second profile and such that the token includes a representation corresponding to the second profile.

5. The method of claim 1, further comprising:
receiving a monetary donation from a third profile, wherein the monetary donation is received with an indication to associate the monetary donation with the performance of the activity; and
wherein generating the token to represent the performance of the activity such that the value of the token depends on the duration of the performance of the activity further comprises:
generating the token such that the value of the token further depends on the monetary donation received from the third profile.

6. The method of claim 1, further comprising:
obtaining, at the computing system, an indication of a set of activities, wherein the indication includes parameters specifying time, location, and skills needed for each activity;
providing a first alert to a first set of profiles having preferences that align with parameters corresponding to a first activity of the set of activities; and
providing a second alert to a second set of profiles having preferences that align with parameters corresponding to a second activity of the set of activities, wherein the particular profile is in one or both of the first set of profiles and the second set of profiles.

7. The method of claim 6, wherein receiving information that indicates the performance of the activity comprises:
receiving information that indicates the performance of the first activity or the second activity.

8. The method of claim 1, wherein associating the token with the particular profile along with the alert that indicates that the token is available comprises:
transmitting the token to a mobile application associated with the particular profile.

9. A system comprising:
a database configured to store a plurality of profiles;
a computing system, wherein the computing system is configured to:
receive information that indicates a performance of an activity, wherein the information specifies a duration of the performance of the activity;
based on the information, determine a particular profile of the plurality of profiles associated with the performance of the activity;
generate a token to represent the performance of the activity such that a value of the token depends on the duration of the performance of the activity; and
associate the token with the particular profile along with an alert that indicates that the token is available.

10. The system of claim 9, wherein the computing system is configured to:
receive sensor data from a mobile computing device associated with the particular profile that indicates the performance of the activity, wherein the sensor data includes movement and duration information.

11. The system of claim 10, wherein the computing system is further configured to:
determine a location of the mobile computing device in response to receiving the sensor data from the mobile computing device to confirm that the mobile computing device was at a location of the activity.

12. The system of claim 9, wherein the computing system is further configured to:
receive a monetary sponsorship from a second profile, wherein the monetary sponsorship is received with an indication to associate the monetary sponsorship with the performance of the activity; and
generate the token such that the value of the token further depends on the monetary sponsorship received from the second profile and such that the token includes a representation corresponding to the second profile.

13. The system of claim 9, wherein the computing system is configured to:
receive a monetary donation from a third profile, wherein the monetary donation is received with an indication to associate the monetary donation with the performance of the activity; and
generate the token such that the value of the token further depends on the monetary donation received from the third profile.

14. The system of claim 9, wherein the computing system is further configured to:
obtain an indication of a set of activities, wherein the indication includes parameters specifying time, location, and skills needed for each activity;
provide a first alert to a first set of profiles having preferences that align with parameters corresponding to a first activity of the set of activities; and
provide a second alert to a second set of profiles having preferences that align with parameters corresponding to a second activity of the set of activities, wherein the particular profile is in one or both of the first set of profiles and the second set of profiles.

15. The system of claim 14, wherein the computing system is further configured to:
receive information that indicates the performance of the first activity or the second activity.

16. The system of claim 9, wherein the computing system is further configured to:
transmit the token to a mobile application associated with the particular profile.

17. A non-transitory computer readable medium having stored therein instructions executable by one or more processors to cause a computing system to perform functions comprising:
receiving information that indicates a performance of an activity, wherein the information specifies a duration of the performance of the activity;
based on the information, determining a particular profile of a plurality of profiles associated with the performance of the activity;
generating a token to represent the performance of the activity such that a value of the token depends on the duration of the performance of the activity; and
associating the token with the particular profile along with an alert that indicates that the token is available.

18. The non-transitory computer readable medium of claim 17, wherein receiving information that indicates the performance of the activity comprises:
receiving sensor data from a mobile computing device associated with the particular profile that indicates the performance of the activity, wherein the sensor data includes movement, location, and duration information

19. The non-transitory computer readable medium of claim 17, wherein receiving information that indicates the performance of the activity comprises:
receiving the information from a second computing system associated with facilitating the activity.

20. The non-transitory computer readable medium of claim 17, wherein the functions further comprise:
receiving a monetary sponsorship from a second profile, wherein the monetary sponsorship is received with an indication to associate the monetary sponsorship with the performance of the activity; and
wherein generating the token to represent the performance of the activity such that the value of the token depends on the duration of the performance of the activity further comprises:
generating the token such that the value of the token further depends on the monetary sponsorship received from the second profile and such that the token includes a representation corresponding to the second profile.
